(19) United States
(12) Patent Application Publication
(10) Pub. No.: US 2025/0119805 A1
(43) Pub. Date: Apr. 10, 2025

(54) SLICE SPECIFIC CELL RE-SELECTION FREQUENCY PRIORITY FOR WIRELESS NETWORKS

(71) Applicants: Nokia Technologies Oy, Espoo (FI); Technische Universität Munich, Munich (DE)

(72) Inventors: Alba JANO, Munich (DE); Halit Murat GÜRSU, Munich (DE); Rakash SIVASIVA GANESAN, Unterhaching (DE); György Tamás WOLFNER, Budapest (HU); Malgorzata TOMALA, Wroclaw (PL); Philippe GODIN, Versailles (FR)

(21) Appl. No.: 18/836,077

(22) PCT Filed: Feb. 9, 2022
(86) PCT No.: PCT/EP2022/053081

§ 371 Date: Aug. 6, 2024

(51) Int. Cl. H04W 36/18; H04W 76/27

(52) U.S. Cl. CPC H04W 36/18; H04W 76/27

(57) ABSTRACT

A method includes receiving, by a user device, slice specific cell reselection information including slice group specific frequency priorities for one or more slice groups, wherein each slice group is associated with one or more network slices; performing, by the user device, a slice specific cell reselection procedure based on the slice specific cell reselection information; during the performing of the cell reselection procedure, logging, by the user device, information related to the slice specific cell reselection procedure; and transmitting, by the user device to a network node, the information related to the slice specific cell reselection procedure to enable setting or adjusting the slice group specific frequency priorities for one or more slice groups for one or more cells.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include: receiving, by a user device, slice specific cell reselection information including slice group specific frequency priorities for one or more slice groups, wherein each slice group is associated with one or more network slices; performing, by the user device, a slice specific cell reselection procedure based on the slice specific cell reselection information; during the performing of the cell reselection procedure, logging, by the user device, information related to the slice specific cell reselection procedure; and transmitting, by the user device to a network node, the information related to the slice specific cell reselection procedure to enable setting or adjusting the slice group specific frequency priorities for one or more slice groups for one or more cells.

According to an example embodiment, a method may include transmitting, by a first network node to a user device, slice specific cell reselection information including slice group specific frequency priorities for one or more slice groups, wherein each slice group is associated with one or more network slices; receiving, by the first network node from a second network node, a slice specific cell reselection report that includes information related to a slice specific cell reselection procedure performed by the user device based on the slice specific cell reselection information including the slice group specific frequency priorities; and adjusting, by first the network node for one or more cells based on the received slice specific cell reselection report, the slice group specific frequency priorities for one or more slice groups.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a flow chart illustrating operation of a UE or user device according to an example embodiment.

FIG. 3 is a flow chart illustrating operation of a gNB or network node according to an example embodiment.

FIG. 4 is a diagram illustrating operation of a system according to an example embodiment.

FIG. 5 is a block diagram of a wireless station or node (e.g., network node, user node or UE, relay node, or other node).

### DETAILED DESCRIPTION

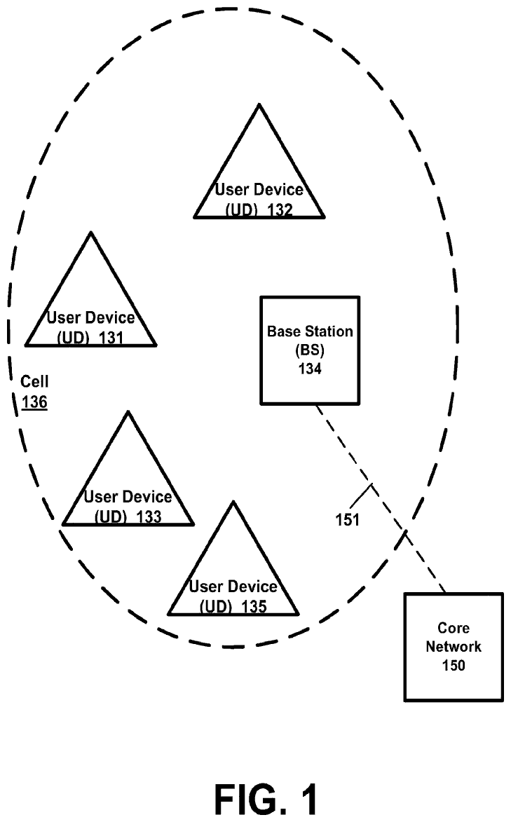

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a SI interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, CU, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to an eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, IoT, MTC, eMTC, eMBB, URLLC, etc., or any other wireless network or wireless technology. These example networks, technologies or data service types are provided only as illustrative examples.

In a connected state (e.g., RRC_Connected) with respect to a cell (or gNB or DU), the UE is connected to a BS/gNB, and the UE may receive data, and may send data (e.g., based on receiving an uplink grant). Also, in a connected state or mode, UE mobility may be controlled by the gNB or network.

In order to conserve power, a UE may, for example, transition from a connected state (e.g., RRC_Connected) to an unconnected state, such as an Idle state (e.g., RRC_Idle) or Inactive state (e.g., RRC_Inactive), e.g., in which the UE may sleep (a low power state) much of the time while in Idle state or Inactive state. In Idle state or Inactive state, the UE does not have a connection established with any cell, and mobility (e.g., determining which cell the UE will be camped on or which cell to select as the serving cell for the UE) is controlled by the cell reselection algorithm running at the UE without active monitoring of any RAN node. While in Idle state or Inactive state, the UE may camp on a serving cell (the cell the UE is camped on), in which the UE may sleep much of the time, and then periodically wake (e.g., changing from a low power state to a full-power state) to perform one or more tasks or processes, e.g., such as receiving system information from the cell the UE is camped on (the serving cell), detecting a paging message from the serving cell (a paging message detected by the UE may indicate that the network has data for downlink transmission to the UE), and other operations. Thus, camping on a cell may include, e.g., a (idle or inactive state) UE waking at specific times or at predefined time intervals, and receiving system information (e.g., system information blocks or SIBs) from the serving cell, receiving paging messages (or monitoring paging resources of the cell for paging message) from the serving cell (the cell the UE is camped on), and/or measuring a signal parameter(s) of a signal from the serving cell.

Initially, a UE may select a cell (e.g., a cell in the PLMN (public land mobile network)) to camp on. After camping on the cell, as noted, at various times after waking from a low power state, the UE monitors (receives) system information (e.g., system information block (SIB)) from the serving cell, monitors paging occasions, detects paging messages from the serving cell, and may perform cell reselection (including measurement of cells). Cell reselection may include, e.g., the UE measuring signals of neighboring cell(s) based on measurement rules, and possibly selecting (reselecting) a (e.g., better or stronger) cell to camp on based on cell reselection criteria and measured signals. Cell reselection criteria may indicate the criteria to select/reselect a cell as the serving cell (or to select the cell the UE will camp on). For example, cell reselection criteria may require (for a neighbor cell to be reselected as the serving cell (or selected to be camped on)), that a measured signal parameter(s) (e.g., such as reference signal received power (RSRP) and/or reference signal received quality (RSRQ)) of the neighbor cell be better or greater than a threshold(s), or better than a threshold plus an offset(s), or other cell reselection criteria. In some cases, a UE may not be required to measure signals from neighbor cells if the measured signal (e.g., RSRP and/or RSRQ) from the serving cell is good enough (e.g., RSRP and/or RSRQ of signal from serving cell is greater than a threshold), e.g., in order to conserve battery power. The UE may perform cell selection and/or cell reselection using cell reselection-related information (e.g., such as one or more cell reselection-related parameters), which, for example, may be received by the UE via the system information (SIBs) broadcast from the serving cell, or from one or more messages (e.g., such as a RRC Connection Release message) sent by the serving cell to the UE.

Thus, for example, cell reselection may include a procedure that the (e.g., idle or inactive state) UE may use to select/reselect a cell to be camped on (to select a cell to be a serving cell while the UE is in inactive or idle state). Cell reselection may include, e.g., measuring signal parameter(s) of the serving cell and/or measuring signal parameter(s) of one or more neighbor cells (cell measurements), evaluating a cell reselection criteria based on the measured signals and cell reselection-related information (or cell reselection-related parameters), and then determining if the cell reselection criteria has been met for a cell, and then camping on that cell if it meets the cell reselection criteria, and/or other functions that may be used to select or reselect a cell. Signal (or cell) measurement may include measuring a signal parameter (e.g., reference signal received power (RSRP) and/or reference signal received quality (RSRQ)) from its serving cell and/or from a neighbor cell.

In some cases, for the search and measurement of intra-frequency and inter-frequency neighboring cells, the serving cell may not necessarily provide a specific (or explicit) neighbor cell list to be measured, but may indicate a carrier frequency (ies) and/or bandwidth information on which cells should be measured for cell reselection. Intra-frequency cell reselection may include measuring neighbor cells on the same carrier frequency (or frequency band), which may be the same carrier frequency or frequency band as the serving cell. Inter-frequency cell reselection may include measuring neighbor cells on different carrier frequencies (or frequency bands), e.g., which may be different than the carrier frequency or frequency band as the serving cell. For example, intra-frequency cell reselection (e.g., selecting a cell among a group of cells on the frequency band) may be performed based on ranking of the cells. The measured cells may be ranked by the UE according to measured RSRP (RSRP of measured reference signals from different cells), and the highest ranked (e.g., having a highest RSRP) cell may be selected by the UE to camp on. Also, for example, for inter-frequency cell reselection (e.g., measuring cells on different frequencies or frequency bands, which may be different from the frequency band of the serving cell), the UE may, for example, select a frequency (e.g., a frequency band) to measure cells' reference signals based on frequency priority (e.g., a highest priority frequency may be selected first), and then the highest cell measured on that high priority carrier frequency or frequency band may be selected to camp on, if it is a suitable cell according to the suitable cell description in 3GPP TS 38.304, for example.

In addition, a network slice may be used by a wireless network to provide a subset (or select set) of UEs or subscribers with access to a specific set of resources or services within a wireless network. Network slicing is (or may include) a separation of multiple virtual networks that operate on the same physical hardware (or physical network), for different applications, services or purposes. Said another way, network slicing may be or may include a network architecture that enables or provides multiplexing of virtualized and independent logical networks on the same physical network infrastructure. Each network slice may be an isolated end-to-end network tailored to fulfill diverse or unique requirements of a particular application. Thus, a network slice may be or may include a virtual network that operates on a shared physical network, to provide a specific service or performance for a set of UEs or for an application(s). A network slice may be or may be allocated a portion of network resources, which may include a portion of radio access network RAN (e.g., gNB) resources and a portion of core network (CN) resources. With network slicing, subscribers/UEs, or applications running on UEs, may belong to different groups, with each group or tenant type having different requirements (e.g., different maximum latency, minimum data rate, different types of security features, . . . , or other different service or performance requirements). Also, traffic (data packets or data) for different network slices may be handled by different protocol data unit (PDU) sessions. Different network slices may be associated with different UE applications, and/or different network slices may provide different resources or services that are directed to meeting requirements of different applications (e.g., browser application, email application, a self-driving car application, robotics application, utility meter reporting applications, . . . ). In some cases, some applications may be classified as a specific application type, such as URLLC, eMBB, IoT, or other type of application, e.g., where a network slice may be provided for each of these different application types. Different applications may have a wide variety of requirements for wireless resources or services. For example, a browser application or email application may have very relaxed latency requirements, while a robotics application may require the ability to frequently transmit small data packets with very low latency.

Therefore, network slicing is a concept to allow differentiated treatment depending on each customer's requirements. With network slicing, it is possible for Mobile Network Operators (MNO) to consider customers as belonging to different tenant types with each having different service requirements that govern what slice types each tenant is eligible to use based on Service Level Agreement (SLA) and subscriptions.

Each network slice may be uniquely identified by a slice identifier, such as a S-NSSAI (Single-Network Slice Selection Assistance Information), which is a combination of a mandatory slice/service type (SST) field, identifying the slice behavior in terms of features and services, and an optional slice differentiator (SD) field, which differentiates among slices with the same SST field. NSSAI (Network Slice Selection Assistance Information) includes one or a list of S-NSSAIs (Single NSSAI).

Support for UE associating with multiple network slices simultaneously: While the network can support large number of slices, the UE need not support more than 8 slices simultaneously. The UE provides to the BS or network, the slice identifier or NSSAI for network slice selection in RRCSetupComplete, if it has been provided by NAS. The Requested NSSAI signalled by the UE to the network allows the network to select the Serving AMF (access and mobility management functions), Network Slice(s) and Network Slice instance(s) for this UE. The UE does not typically include the Requested NSSAI in the RRC Resume when the UE asks to resume the RRC connection and is CM-CONNECTED with RRC Inactive state.

In case a where a UE is associated with multiple network slices (or simply slices) simultaneously, UE monitors only paging occasions from a single cell as the network aims to page the UE only from one cell, and for intra-frequency cell reselection, the UE typically attempts to camp on the best cell where it will monitor the paging occasions (e.g., highest ranked cell or cell with best or highest RSRP). For inter-frequency cell reselection, dedicated priorities (or frequency prioritites) can be used to control the frequency on which the UE camps or selects the cell as a result of performing cell reselection (or can be used to control the frequency which the UE may measure reference signals from one or more cells). The frequency may refer to a frequency or frequency band on which a cell may transmit reference signals, such as synchronization signaling block (SSB) reference signals or channel state information-reference signals (CSI-RS) reference signals. Thus, a UE may measure RSRP of a cell on this frequency.

Resource management between slices: NG-RAN supports policy enforcement between slices as per service level agreements. It should be possible for a single NG-RAN node to support multiple slices. The NG-RAN should be free to apply the best RRM (radio resource management) policy for the SLA in place for each supported slice.

Slice Availability: Some slices may be available only in part of the network. The NG-RAN (5G RAN or network nodes) supported S-NSSAI(s) is configured by OAM (operations, administration and management). Awareness in the NG-RAN of the slices supported in the cells of its neighbors may be beneficial for inter-frequency mobility in connected mode. It is assumed that the slice availability does not change within the UE's registration area. Admission or rejection of access to a slice may depend on factors such as support for the slice, availability of resources, support of the requested service by NG-RAN.

Also, a slice group may be associated with one or more network slices (or slices). The network (e.g., core network and/or BS/gNB) may assign one or more frequency priorities for each slice group, for each of one or more cells.

As noted, each slice may be associated with a SLA (to provide a specific level of service). And a slice group may be associated with one or more slices:
Slice group 1: URLLC (slice A), eMBB (slice B);
Slice group 2: V2X (slice C), eMBB (slice D);
Frequency priorities for slice specific cell reselection, may be assigned or configured for each cell.
Slice group frequency priorities: for example:
Slice group 1: URLLC (slice A), eMBB (slice B);
Frequency 1, slice group 1, priority 2;
Frequency 2, slice group 1, priority 4 (which is higher than priority 2);
In this example, for slice group 1, the frequency 2 is a higher priority frequency than frequency 1.

As an illustrative example, the network (e.g., gNB and/or core network) may want to perform idle/inactive state load balancing for UEs, e.g., so UEs will be more likely to camp on cells of certain frequencies, and ensure that these cells support the requested slices of the UE(s). So, in this way, the UE can camp on cells that support its slices (configured slices, requested slices, allowed slices).

As an illustrative example: TS 23.501 defines the following:

“Allowed NSSAI (allowed slice): NSSAI provided by the Serving PLMN (public land mobile network) during, e.g., a Registration procedure, indicating the S-NSSAIs (slice) values the UE could use in the Serving PLMN for the current Registration Area.

Configured NSSAI (configured slice): NSSAI (slice) provisioned in the UE applicable to one or more PLMNs.

Requested NSSAI (requested slice): NSSAI (slice) provided by the UE to the Serving PLMN during registration.

Pending NSSAI (pending slice): NSSAI (slice) provided by the Serving PLMN during a Registration procedure, indicating the S-NSSAI(s) for which the network slice-specific authentication and authorization procedure is pending.

Subscribed S-NSSAI (subscribed slice): S-NSSAI based on subscriber information, which a UE is subscribed to use in a PLMN”

If a UE camps on a cell that does not support the UE's slice, the UE may establish a connection to a cell (that does not support the UE's slice) and sends a service request to the network for a slice, and the core network (e.g., AMF) would reject this service request because the cell does not support the requested slice, and the UE may return to Idle mode after service is rejected, which may cause a delay for service initiation for the UE. Therefore, it may be desirable to avoid the UE having service rejected by the network for a specific service. Slice specific cell reselection may be used to avoid (or at least decrease the likelihood) a situation where a UE camps on a cell that does not support its slice. Rejection of the service may mean the AMF (core network) refuses to establish a session for that slice over the RAN node UE is connected to.

Slice specific cell re-selection: Slice specific cell re-selection modifies the cell re-selection procedure in multiple ways.

1) UE is configured with available slices and related (or associated) slice groups through NAS (non-access stratum) signalling (where NAS signalling may include the protocol layers of PHY (physical layer), MAC (Media access control), RRC (radio resource control) or other network protocols) or dedicated RRC signalling. For example: Slice group 1: URLLC, eMBB; Slice group 2: V2X, eMBB.

2) UE may be informed about slice specific frequency priorities through dedicated signalling or via system information block (SIB) broadcast from gNB or network node. The frequency priorities are set by the serving cell and may typically be different for different cells.

SIB broadcast from a cell covers or may indicate frequency priorities for different separate slice groups for the cell. For example:

Frequency 1: Slice group 1 priority 2, slice group 2 priority 3.

Frequency 2: Slice group 1 priority 4, slice group 2 priority 1

3) UE NAS provides to AS (access stratum protocol layer) the selected slice group for cell reselection.

For example: Slice group 1

4) UE uses the slice group provided by the AS to set the frequency priority for cell reselection. In the above example:
Frequency 1: Priority 2
Frequency 2: Priority 4 (e.g., where priority 4 may be considered a higher priority than priority 2)

5) UE uses the frequency with highest priority to initiate cell re-selection. For example: Frequency 2 (for this slice group).

6) UE receives and measures RSRP of reference signals of cells on the highest priority frequency. The UE may receive and/or measure reference signals from multiple cells on a frequency at a time. The cell measurement may be repeated for one or more frequencies. The UE searches through frequencies until it finds a suitable cell (e.g., having a RSRP of reference signal above a threshold) that supports its slices. However, the new cell may or may not support the slice the UE is interested in. However, one or more of the cells surrounding the serving cell may support the slices associated with slice group 1 with higher probability in Frequency 2 rather than in Frequency 1. Hence, slice specific cell reselection may reduce signalling and latency involved in searching for a suitable cell.

Therefore, the slice related cell reselection information may enable: 1) Avoiding the increase in the control plane signalling overhead and latency for UE to access the service when the serving cell cannot support the service and needs to redirect the UE or perform handover to a suitable cell to provide service. 2) Awareness of UE for the supported slices on different cells or frequencies. 3) Different frequency priority configurations for a specific slice in different areas, enabling area specific RAN load balancing for different slices.

For the above to be achieved, it is important that the slice specific frequency priorities are set or adjusted appropriately. Setting the slice specific frequency priorities in a non-optimal way for cell re-selection may cause one or more of the following problems, as illustrative examples: 1) a UE may end up being rejected often for its service request after it connects to a selected cell, e.g., such as if a cell in a frequency does not support the slice of the UE; 2) the UE may not end up camping at the best cell for service support; 3) the UE may end up camping on a cell where its preferred slice is a lower priority and thus the UE cannot obtain service due to high load of the high priority slice, leaving few resources at the cell available for the UE's slice, even though the cell supports such slice; and/or, 4) the UE may end up performing multiple or too many cell searches in frequency bands that it cannot find a suitable cell. One or more of these problems (or other problems) in slice specific cell reselection may cause a delay for service initiation related to (or for) the slice group for the UE.

Furthermore, the network (e.g., BS/gNB and/or core network) has the ability to update and change the slice (or slice group) specific frequency priorities for a cell. However, currently the network cannot determine the type of misconfiguration or problems that may have occurred from network operation, as there is little to no information reported back to the cells or gNBs related to the problems of a slice specific cell reselection procedure. Thus, currently, the gNBs are unable to adequately adjust frequency priorities for slice groups due to a lack of relevant information associated with performed slice specific cell reselection procedures, e.g., such as problems experienced during slice specific cell reselection procedures.

For example, currently, a gNB or network node does not know which slice specific frequency priority is (or was) used by the UE during a slice specific cell reselection for a slice group that resulted in one of the above misconfiguration problems. Also, each cell may provide, e.g., via SIB broadcast or separate message(s), the slice specific cell re-selection frequency priorities. According to an example embodiment, in order to re-select to a neighbor cell, the UE uses the slice specific frequency priorities provided (e.g., broadcast) by the serving cell to determine which neighbor cells to measure (e.g., those neighbor cells that transmit reference signals on a highest priority frequency for the UE's slice group, for example). Also, cells are not aware of the slice specific cell re-selection parameters (e.g., such as frequency priorities) of its neighbor cells.

Therefore, according to an example, embodiment, a UE (or user device) may receive slice specific cell reselection information from a cell or network node (e.g., via system information block (SIB) and/or a RRCRelease message), e.g., including slice group specific frequency priorities for one or more slice groups for the cell. A slice group is associated with one or more network slices. The UE may also receive from the network node or cell a list of allowed slices for the UE (wherein the UE may use any of these allowed slices), and a slice-slice group mapping information that indicates a slice group associated with each network slice. The UE may perform a slice specific cell reselection procedure. During the performing of the slice specific cell reselection procedure, the UE may log (e.g., record or store) information related to the slice specific cell reselection procedure. The UE may transmit (e.g., after establishing a connection to a cell or network node) the logged information related to the slice specific cell reselection procedure to a network node to enable one or more network nodes to adjust slice group specific frequency priorities for one or more slice groups for one or more cells.

Example embodiments provide UE logging of information related to a (or one or more) slice specific cell reselection procedure(s). The UE may log information (e.g., problems or other information related to the slice specific cell reselection procedure(s)) related to the slice specific cell reselection procedure and send or transmit this information to a gNB or network node to report one or more problems or other information, and may also report or indicate the slice specific cell reselection priority (ies) and/or slice group(s) used by the UE for slice specific cell reselection. For example, a UE may compile or create a report, e.g., which may be sent to a connected gNB as or via a SON (self-organizing networks) report or RFSP (RAT/Frequency Selection Priority) report, after the UE performs a slice specific cell re-selection procedure.

After establishing a connection to a network node (e.g., gNB), the UE may forward that information related to the slice specific cell reselection procedure to the gNB that the UE is connected to (the serving gNB). The information that is logged and forwarded to the connected (or serving) gNB may include one or more details, parameters, information indicating or describing a problem(s) that occurred during cell reselection procedure, or other information related to the slice specific cell reselection procedure performed by the UE. The serving gNB (that is connected to the UE and receives the information), may prepare a slice specific cell reselection report based on the received information related to the slice specific cell reselection procedure, and may forward this slice specific cell reselection report to one or more other gNBs. The serving gNB (that prepared and sent the slice specific cell reselection report) and/or the other gNB(s) (that received the slice specific cell reselection report) may use the slice specific cell reselection report to improve or perform self-optimization of slice specific cell re-selection settings for one or more cells. The self-optimization of slice specific cell reselection settings may be achieved by (or may include), for example, changing (e.g., setting or adjusting) the slice group specific frequency priorities for a cell or for multiple cells.

In this manner, this slice specific cell reselection report may allow a network node (or gNB) to determine a root cause for one or more problems or performance issues, and then may adjust the slice group specific frequency priorities to improve network or cell performance for one or more slices or slice groups, e.g., to reduce a service initiation delay(s) related to a slice or slice group for one or more cells, or to achieve other performance improvement.

A gNB receiving (from a UE) information related to a slice specific cell reselection procedure may prepare and forward a slice specific cell reselection report, which may include at least a portion of this information related to a slice specific cell reselection procedure, to one or more neighbor gNBs or network nodes, to allow these neighbor network nodes to set or adjust slice group specific frequency priorities for one or more cells based on problems or events that may have occurred during slice specific cell reselection procedures that may have been performed by the UE based on slice specific cell reselection information (e.g., including slice group specific frequency priorities) for one or more of their cells (e.g., broadcast via SIB via one or more of their cells).

For example, a UE may perform a cell reselection procedure, which may include, as an illustrative example, performing the following one or more times: selecting, by the UE, a slice group among one or more slice groups of the UE or user device, to perform the slice specific cell reselection procedure; selecting, by the UE, at least one frequency based on the slice group specific frequency priorities for the selected slice group; measuring, by the UE, reference signals from a plurality of cells via the selected at least one frequency at least once as configured by the network; ranking the plurality of cells based on the measuring; selecting, by the UE, a highest ranked cell among the plurality of cells; receiving system information from the selected cell to confirm that the selected cell supports the selected slice group; and camping, by the UE, the selected cell. The UE may log, e.g., during the slice specific cell reselection procedure, information related to the slice specific cell reselection procedure. The UE may also establish a connection with a cell or gNB/network node and then send the information related to the slice specific cell reselection procedure, which may include information indicating one or more problems, events or occurrences that may have occurred during the cell reselection procedure.

According to an example embodiment, the one or more problems or occurrences (or information related thereto) that may have occurred during or related to a slice specific cell reselection procedure, which may be logged and reported by the UE, may include, for example, one or more of the following: whether the slice specific cell reselection procedure included intra-frequency or inter-frequency cell reselection; the last selected slice specific frequency priority; the selected slice group for which slice group specific frequency priorities were considered by the UE to select the cell, e.g., highest priority frequency for measuring cell reference signals, the steps or operations that led to the final selection (such as a list of [slice group, frequency] pairs that the UE went through during cell measurement). For each slice group, the information related to the slice specific cell reselection procedure may, for example, indicate statistics for failed (and/or successful) cell reselections. The logged and forwarded information related to the slice specific cell reselection procedure may include, e.g., a (selected) slice group, frequency, and highest ranked cell ID per frequency (or maybe the information that the SIB of the highest ranked cell indicates that it does not support slice group); or the logged and reported information related to the slice specific cell reselection procedure may include information indicated the UE connected to a cell, but service was rejected, e.g., due to load, or load balancing by core network, or due to lack of resources available at that cell for that particular slice or slice group. In many cases, SIB information indicating supported slices or slice groups may not indicate traffic loads or availability of resources at the cell for each slice or slice group. The information related to the slice specific cell reselection procedure that may be logged and forwarded by the UE may include a list or indication of one or more suitable cells (e.g., having a reference signal with a signal power/RSRP above a threshold) which may have been eliminated at each step of the process as not supporting the required slices, e.g., based on SIB information received by UE indicating that the cell does not support the slice or slice group of the UE.

If a UE includes multiple slice groups, various techniques may be used by the UE to determine or select a slice group, such as: slice group may be selected by NAS (non-access stratum) protocol entity, or slice group selection can be controlled by UE or network (e.g., gNB or core network); or a highest QoS or highest priority slice group may be selected. Once a slice group has been selected by the UE, the UE may determine a frequency to perform cell measurement, based on slice group specific frequency priorities.

As noted, the UE may log and forward to a gNB, information related to the slice specific cell reselection procedure, which may include information describing or associated with a problem that occurred for the UE in performing the slice specific cell reselection procedure, wherein the problem may have resulted in and/or caused a service initiation delay (e.g., delayed service being accepted by a cell for the UE for the slice or slice group) related to a slice or slice group. According to an example embodiment, the information describing or associated with a problem may include at least one of: an indication of one or more cells that were selected by the UE based on measurement of reference signals, but where such one or more cells did not support a slice group used by the UE for the slice specific cell reselection procedure; an indication of one or more cells where the UE established a connection to the cell, but where a service request was rejected; an indication of one or more cells where the UE established a connection to the cell, but where a service request was rejected at least for a slice group that was used by the UE for the slice specific cell reselection procedure or was indicated by the UE in a service request; an indication that no suitable cells, having a reference signal received power greater than a threshold, of an indicated frequency were found (detected) by the UE that support a slice group used by the UE for the slice specific cell reselection procedure; measurement related information, including a number of cell measurements or a number of frequencies measured; a service initiation delay after the slice specific cell reselection procedure was started until service was accepted for a selected slice group for the UE; a number of service request rejections and/or admission control rejections for the UE; and/or an indication of whether the UE performed multiple measurement iterations of measuring, by the UE, reference signals on the at least one frequency.

According to an example embodiment, a first gNB (on which the UE is camped on while in inactive or idle state) may provide slice group specific frequency priorities to the UE. The UE may determine a frequency or frequencies to measure cell reference signals during the slice specific cell reselection procedure, based on the slice group specific frequency priorities received by the UE from the gNB that the UE has camped on. After slice specific cell reselection procedure is performed by the UE, the UE may establish a connection to a cell of a second gNB, and may send to the second gNB the logged information related to the slice specific cell reselection procedure. Based on this information related to the information related to the slice specific cell reselection procedure received from the UE, the second gNB may prepare and forward a slice specific cell reselection report to the first gNB that provided the slice group specific frequency priorities that were used by the UE for the slice specific cell reselection procedure. This may allow the first gNB to adjust its slice group specific frequency priorities, e.g., to improve performance, perform load balancing of traffic for this slice or slice group among other frequencies, etc.

As an illustrative example, a first gNB (having a serving cell that the UE is currently connected to) may receive information related to the slice specific cell reselection procedure from the UE, where this information indicates that the UE measured cells of a first frequency that was the highest priority frequency for a slice group of the UE, and selected a cell of a second gNB (based on a RSRP of reference signals received from the cell of the second gNB), confirmed that the selected cell of the second gNB supported the UE slice group (e.g., by receiving SIB from this cell of the second gNB), but the service request sent by the UE to the second gNB for such slice group was rejected (e.g., due to load balancing, or due to insufficient resources available at that cell of the second gNB for such UE slice group). Thus, based on this information, both or either of the first gNB and/or the second gNB may adjust their slice group specific frequency priorities for this slice group to a lower priority, which may cause other UEs having this slice group to select a different (higher priority) frequency to perform cell reselection, since this cell of the second gNB does not currently have adequate resources for this slice group. This is merely a simple illustrative example, and other factors and/or other information of received reports may be used to adjust slice group specific frequency priorities.

Also, a gNB or network node (as well as a UE) may maintain a timer per slice or slice group to measure a service rejection time period or a service initiation delay time period for a slice or slice group, which may be the time period (or amount of time) during which a slice or slice group is rejected (or has not received service via a service accept message for a slice or slice group) after service was requested for example. For example, a UE may have requested service for a slice by sending a service request, and was rejected (service request was rejected), and then the gNB may record or log the amount of time the UE was not able to access this slice, until it had service accepted at a cell (e.g., time period from when service request was rejected until when the service request was accepted for a slice or slice group). A service request sent by a UE to a gNB or network node may indicate the slice groups of the UE. A service accept message from the gNB or network may accept service for all slice groups of the UE, or may accept a subset of the indicated slice groups of the UE. Rejection of one or more slice groups may typically be followed by RRCRelease message sent by gNB to UE to return the UE to Idle or Inactive state to perform cell reselection, or the gNB or network may send the UE a message to perform a handover to another cell, which takes time (and thus causes further service initiation delay for that slice or slice group of the UE). Thus, a gNB or cell may track the time periods or duration for which it could not serve the UE. Also, each UE may also log the period of time or duration for which it was not served by a cell, after it requested service for a slice or slice group. The UE may report this information to a cell or gNB that the UE is connected to, as part of the information related to slice specific cell reselection.

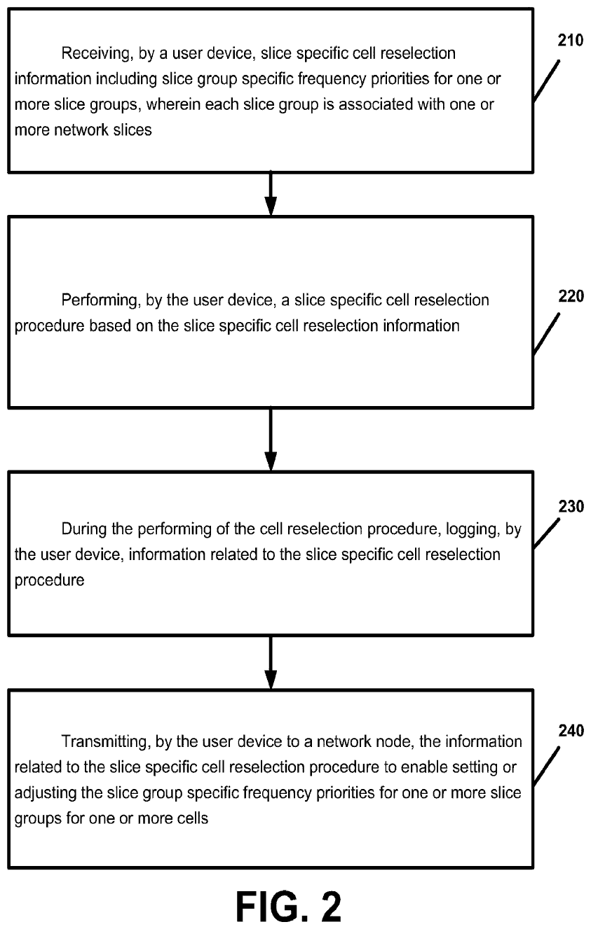

FIG. 2 is a flow chart illustrating operation of a UE or user device according to an example embodiment. Operation 210 includes receiving, by a user device (or UE), slice specific cell reselection information including slice group specific frequency priorities for one or more slice groups, wherein each slice group is associated with one or more network slices. Operation 220 includes performing, by the user device, a slice specific cell reselection procedure based on the slice specific cell reselection information. Operation 230 includes during the performing of the cell reselection procedure, logging, by the user device, information related to the slice specific cell reselection procedure. Operation 240 includes transmitting, by the user device to a network node, the information related to the slice specific cell reselection procedure to enable setting or adjusting the slice group specific frequency priorities for one or more slice groups for one or more cells.

With respect to the method of FIG. 2, the performing the slice specific cell reselection procedure may include performing the following, for example: selecting, by the user device, a slice group among one or more slice groups of the user device, to perform the slice specific cell reselection procedure; selecting, by the user device, a frequency having a highest priority among a plurality of slice group specific frequency priorities for the selected slice group; performing the following one or more times: measuring, by the user device, reference signals from a plurality of cells via the selected at least one frequency; and selecting, by the user device, a cell among the plurality of cells, based on the measuring. For example, the performing the slice specific cell reselection procedure may include confirming, by the user device, that the selected cell supports the selected slice group (e.g., by receiving SIB information, or a message, indicating slices or slice groups supported by the selected cell).

The method of FIG. 2 may further include performing the following one or more times: performing, by the user device, a RRC (radio resource control) connection setup procedure (e.g., which includes establishing a connection via random access procedure) with the selected cell to establish a connection with the selected cell; and attempting to initiate service by sending a service request to the connected cell. For example, the attempting to initiate service may include: transmitting, by the user device to the selected cell, a service request message to request service for one or more slice groups of the user device including at least for the selected slice group; and performing at least one of the following: receiving one of the following: a service accept message that indicates that the service request has been accepted, or a service reject message that indicates that the service request has been rejected; or determining that a service accept message has not been received by the user device, thereby indicating that the service request has likely been rejected.

According to an example embodiment for the method of FIG. 2, the performing the slice specific cell reselection procedure may include performing the following: selecting, by the user device, a slice group among one or more slice groups of the user device, to perform the slice specific cell reselection procedure; selecting, by the user device, at least one frequency based on the slice group specific frequency priorities for the selected slice group; measuring, by the user device, reference signals from a plurality of cells via the selected at least one frequency at least once as configured by the network; ranking the plurality of cells based on the measuring; selecting, by the user device, a highest ranked cell among the plurality of cells; receiving system information from the selected cell to confirm that the selected cell supports the selected slice group; and camping, by the user device, on the selected cell.

According to an example embodiment for the method of FIG. 2, the selecting at least one frequency may include: selecting, by the user device, at least one frequency having a highest priority for the selected slice group based on the slice group specific frequency priorities for the selected slice group.

According to an example embodiment for the method of FIG. 2, the information related to the cell reselection procedure that is (or may be) logged by the user device may include at least: a slice group specific frequency priority used by the user device for the slice specific cell reselection procedure; and information describing or associated with a problem that occurred for the user device in performing the slice specific cell reselection procedure, wherein the problem caused or resulted in a service initiation delay related to a slice or slice group for the user device. Furthermore, the information related to the cell reselection procedure that is logged by the user device may include a slice group and a slice group specific frequency priority used by the user for the slice specific cell reselection procedure.

According to an example embodiment for the method of FIG. 2, the information describing or associated with a problem may include, for example, at least one of: an indication of one or more cells that were selected by the user device based on measurement of reference signals, but where such one or more cells did not support a slice group used by the user device for the slice specific cell reselection procedure; an indication of one or more cells where the user device established a connection to the cell, but where a service request was rejected; an indication of one or more cells where the user device established a connection to the cell, but where a service request was rejected at least for a slice group that was used by the user device for the slice specific cell reselection procedure or was indicated by the user device in a service request; an indication that no suitable cells, having a reference signal received power greater than a threshold, of an indicated frequency were found that support a slice group used by the user device for the slice specific cell reselection procedure; measurement information, including a number of cell measurements or a number of frequencies measured; a service initiation delay after the slice specific cell reselection procedure was started until service was accepted for a selected slice group for the user device; a number of service request rejections and/or admission control rejections for the user device; and an indication of whether the user device performed multiple measurement iterations of measuring, by the user device, reference signals on the at least one frequency.

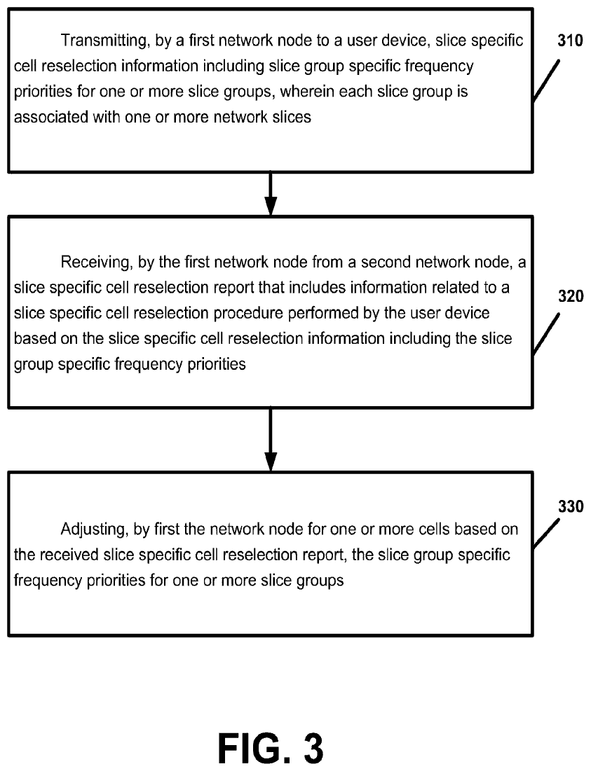

FIG. 3 is a flow chart illustrating operation of a gNB or network node according to an example embodiment. Operation 310 includes transmitting, by a first network node to a user device, slice specific cell reselection information including slice group specific frequency priorities for one or more slice groups, wherein each slice group is associated with one or more network slices. Operation 320 includes receiving, by the first network node from a second network node, a slice specific cell reselection report that includes information related to a slice specific cell reselection procedure performed by the user device based on the slice specific cell reselection information including the slice group specific frequency priorities. And, operation 330 includes adjusting, by first the network node for one or more cells based on the received slice specific cell reselection report, the slice group specific frequency priorities for one or more slice groups.

According to an example embodiment for the method of FIG. 3, the slice specific cell reselection report includes information, reported by the user device to the second network node, related to a slice specific cell reselection procedure performed by the user device based on the slice specific cell reselection information transmitted by the first network node to the user device.

According to an example embodiment for the method of FIG. 3, the slice specific cell reselection report may include at least: a slice group specific frequency priority used by the user device for the slice specific cell reselection procedure; and information describing or associated with a problem that occurred for the user device in performing the slice specific cell reselection procedure, wherein the problem caused or resulted in a service initiation delay for the user device.

According to an example embodiment for the method of FIG. 3, the slice specific cell reselection report may further include: an indication of whether or not the user device performed multiple measurement iterations of measuring reference signals on at least one or a same frequency.

According to an example embodiment for the method of FIG. 3, the slice specific cell reselection report may include at least: a slice group and a slice group specific frequency priority used by the user device for the slice specific cell reselection procedure.

According to an example embodiment for the method of FIG. 3, the information describing or associated with a problem that occurred for the user device in performing the slice specific cell reselection procedure may include at least one of: an indication of one or more cells that were selected by the user device based on measurement of reference signals, but where such one or more cells did not support a slice group used by the user device for the slice specific cell reselection procedure; an indication of one or more cells where the user device established a connection to the cell, but where a service request was rejected; an indication of one or more cells where the user device established a connection to the cell, but where a service request was rejected at least for a slice group that was used by the user device for the slice specific cell reselection procedure or was indicated by the user device in a service request; an indication that no suitable cells, having a reference signal received power greater than a threshold, of an indicated frequency were found that support a slice group used by the user device for the slice specific cell reselection procedure; measurement information, including a number of cell measurements or a number of frequencies measured; a service initiation delay after the slice specific cell reselection procedure was started until service was accepted for a selected slice group for the user device; and a number of service request rejections and/or admission control rejections for the user device; a list of cells, that satisfy a cell reselection measurement criteria, that were found on each measurement iteration on at least one frequency.

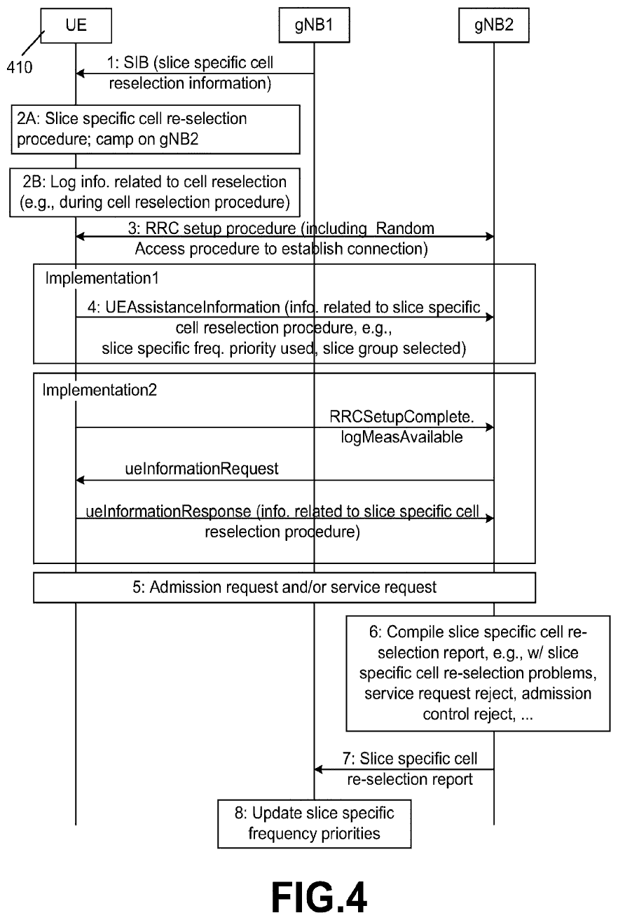

FIG. 4 is a diagram illustrating operation of a system according to an example embodiment, based on the operation of FIGS. 2-3. Further details will be described in FIG. 4. As shown in FIG. 4, a UE 410, which may at least initially be in Inactive state or Idle state for example, may be in communication with gNB1 and gNB2. Although not shown, UE 410 may receive (e.g., via system information or via one or more messages) information indicating allowed network slices (slices), and information indicating network slices associated with each of one or more slice groups. UE 410 may be camping on a cell of gNB1.

At step 1, UE 410 may receive slice specific cell reselection information, which may include, e.g., at least slice group specific frequency priorities for one or more slice groups, from the cell UE 410 is camping on, e.g., gNB1. For example, the UE 410 may receive information indicating the following slice group specific frequency priorities for slice group 1:
Frequency 1: Priority 2;
Frequency 2: Priority 4 (e.g., where priority 4 may be considered a higher priority than priority 2).

At step 2A of FIG. 4, UE 410 performs a slice specific cell re-selection procedure to find a suitable (e.g., having a RSRP of reference signals greater than a threshold) cell, e.g., a cell of gNB2. UE 410 camps on a selected cell of gNB 2. Thus, in this example, frequency 2 is the highest priority frequency for slice group 1. Thus, for example, based on the received slice group specific frequency priorities for slice group 1, the UE 410 may select a frequency (e.g., such as the highest priority frequency for slice group 1) for performing slice specific cell reselection procedure (e.g., for measuring cells as part of the cell reselection procedure). In this example, the highest priority frequency (Frequency 2 in this example) for the slice group of the UE 410 may be or indicate the frequency on which the UE may or should first (or prioritize) attempt to measure reference signals of cells to select a cell for cell reselection. If, for example, measurement of cells on Frequency 2 do not result in identifying a suitable cell, then the UE may perform another iteration of cell measurement (perform cell measurement again) on Frequency 2, or the UE may perform cell measurement on the next highest priority frequency (e.g., Frequency 1 in this example). If no suitable cells are found by performing cell measurement based on frequencies for slice group 1, then the UE may select one or more frequencies based on another slice group of the UE to perform cell measurement. This process may be repeated for one or more slice groups, until a suitable cell is found (e.g., having a RSRP greater than a threshold) and which supports the slice or slice group of the UE.

In general, according to an example embodiment, slice specific cell reselection procedure may include the UE (or user device) performing the following, for example: selecting, by the UE, a slice group among one or more slice groups of the UE, to perform the slice specific cell reselection procedure; selecting, by the UE, a frequency having a highest priority among a plurality of slice group specific frequency priorities for the selected slice group; performing the following one or more times: measuring, by the UE, reference signals from a plurality of cells via the selected at least one frequency; and selecting, by the UE, a cell among the plurality of cells, based on the measuring (e.g., selecting the cell having the highest measured RSRP of reference signals). Also, the performing the slice specific cell reselection procedure may include confirming, by the UE, that the selected cell supports the selected slice group (e.g., by receiving SIB information, or a message, indicating slices or slice groups supported by the selected cell). If the cells supports the slice group of the UE (e.g., slice group 1), then the UE may camp on that cell. However, a number or problems, issues, events or occurrences may arise during the slice specific cell reselection procedure that may be logged or recorded by the UE, to be reported to a gNB, which may be used to adapt or adjust slice or slice group specific frequency priorities.

At step 2B, UE 410 may log (e.g., store or record) information related to the slice specific cell reselection procedure. Thus, for example, while the UE 410 may eventually camp on a cell of gNB2, the UE 410 may have gone through one or more measurement iterations or operations, e.g., before finding a suitable cell that supports the slice or slice group of UE 410. Various types of information related to the slice specific cell reselection procedure may be logged by UE 410. At step 2B, UE 410 may log one or more details, parameters, problems, or other information, related to the slice specific cell reselection procedure performed by the UE. This information logged by UE 410 may include one or more of: a slice group specific frequency priority used by the user device for the slice specific cell reselection procedure, or the logged information may include both a slice group and a slice group specific frequency priority used by the user for the slice specific cell reselection procedure. UE 410 may also log information describing or associated with a problem (e.g., issue, occurrence, or event) that occurred for the user device in performing the slice specific cell reselection procedure, wherein the problem caused or resulted in a service initiation delay related to a slice or slice group for the user device. As an illustrative example, the information describing or associated with a problem that may be logged by UE 410 (to be reported to a gNB), may include one or more of the following: an indication of one or more cells that were selected by the user device based on measurement of reference signals, but where such one or more cells did not support a slice group used by the user device for the slice specific cell reselection procedure; an indication of one or more cells where the user device established a connection to the cell, but where a service request was rejected; an indication of one or more cells where the user device established a connection to the cell, but where a service request was rejected at least for a slice group that was used by the user device for the slice specific cell reselection procedure or was indicated by the user device in a service request; an indication that no suitable cells, having a reference signal received power greater than a threshold, of an indicated frequency were found that support a slice group used by the user device for the slice specific cell reselection procedure; measurement information, including a number of cell measurements or a number of frequencies measured; a service initiation delay after the slice specific cell reselection procedure was started until service was accepted for a selected slice group for the user device; a number of service request rejections and/or admission control rejections for the user device; and an indication of whether the user device performed multiple measurement iterations of measuring, by the user device, reference signals on the at least one frequency.

At step 3 of FIG. 4, the UE 410 performs a RRC setup procedure, including establishing a connection with the cell of gNB2 via random access (RACH) procedure with the cell of gNB2, in order to establish a connection with the new camped cell of gNB2.

At step 4, the UE 410 may transmit (e.g., all or at least a portion of) the logged information related to the slice specific cell reselection procedure to the cell of the gNB2. For example, the UE 410 may, for example, transmit this logged information during or right after the first establishment/resumption of the connection after camping on a cell. For example, this logged information may be transmitted using two different techniques or implementations. Thus, two example implementations are described for the UE to send its logged information related to the slice specific cell reselection procedure.

In a first implementation (implementation 1) of step 4, the UE may transmit or send or report the information related to the slice specific cell reselection procedure via UE assistance information to gNB2. In a second implementation (implementation 2) of step 4, the UE may send the logged information related to the slice specific cell reselection procedure to gNB2 via a UE information response that may be sent upon request based on an indication (e.g., a logMeasAvailable flag is set) provided by the UE to gNB2 that the report is available.

### Implementation 1. The UE Assistance Information Message:

The UE assistance information message may include any of information a)-e) below, for each slice group if multiple slice groups went through the process: Also, after UE selects a slice group of multiple cells, if UE is unable to select a cell based on slice specific cell reselection, UE may or may select a different slice group it is using, and may repeat this selection process:

a) The assistance information may indicate the slice group and/or the frequency priority used by the UE for slice specific cell reselection. Various techniques may be used by the UE to select a slice or slice group to use for selecting a frequency to measure reference signals as part of slice specific cell reselection. The slice group may be, for example, the slice group indicated by the UE NAS (non access stratum protocol entity) to AS (access stratum) to be used for slice specific cell re-selection. UE may indicate the slice group used for the selection process. UE selects one slice group among a plurality of slice groups the UE wants to have service for. UE NAS indicates this (received from some CN signaling, or might be UE implementation); this info that UE determined slice group based on either CN signaling or UE implementation, or can even be based on RRC signaling and known by AS/protocol entities. UE may randomly select a slice group of a plurality of UE slice groups, or may select a slice group with a specific QoS requirement (e.g., having shortest latency requirement).

b) UE may indicate the frequency priorities used by the UE for slice specific cell re-selection procedure at each step of the procedure (one step corresponding to one frequency priority). Thus, the UE indicates the frequency priority (or frequency priorities) used for selected slice group for measuring cells as part of slice specific cell reselection procedure.

c) UE may indicate the amount of measurements to find a suitable cell at each step. For example, this amount of measurements may include how many frequencies or frequency bands the UE had to measure (the UE may measure multiple cells of a frequency at the same time).

d) UE may track and log, and then transmit or report (in the logged information UE sends the gNB) service initiation delay after cell re-selection procedure was initiated or started until it finally received service, e.g., which may indicate an amount of delay in ms or seconds, such as in a case where a UE has selected a cell where the core network or AMF rejected a service request for that cell, for example.

e) UE may indicate that a cell found with slice specific cell re-selection was checked for slice support (e.g., based on received SIB information from the cell indicating slices or slice groups supported by the cell). After UE measures cells of the frequency band, and selects cell with highest RSRP, and then UE checks if that cell supports this slice (it checks SIB broadcasted by that cell for the slices or slice groups supported by the cell). So UE might select the best cell in the priority frequency band that supports a slice or slice group, or may refrain from selecting a cell that does not support the slice.

### Implementation 2.

In a second implementation (implementation 2), UE 410 may signal a single bit (e.g., a log measure available flag or bit) by transmitting a notification to gNB2 without passing the actual contents of the report/logged information. For example, UE may send a RRC Setup Complete message that may include a field or flag (e.g., logmeasAvailable flag is set) indicating that the report (including the information related to the slice specific cell reselection procedure) is available from the UE. The same information sent via Implementation 1 may be sent via Implementation 2.

Alternatively with RRC Setup Request/RRC Resume complete/Handover Complete. The message for this implementation is sent based on a poll (UE information request) received by UE 410 from gNB2, after RRCsetup complete message is received by gNB2.

The gNB where the UE established RRC connection (e.g., gNB2) decides about the slice specific report retrieval by UEInformationRequest/UEInformationResponse

The UE transmits in the UE Information Response that may include the report that includes the information related to the slice specific cell reselection procedure, e.g., which may be the same information as described in the UE Assistance Information.

Thus, for example, in some cases, at step 5, UE 410 may be admitted or rejected for service by core network for a particular slice or slice group. The details of admission or rejection (e.g., for previous cells, as part of the slice specific cell reselection procedure) may be reported via assistance information. UE 410 may perform cell reselection, and may attempt to obtain service (admitted for that slice or slice group). To obtain service for the UE slice or slice group, the UE sends a service request to RAN node/AMF, and may receive a service admission or rejection reply for that slice or slice group (or may fail to receive a service. The UE may send the report with the information related to the slice specific cell reselection procedure via UE assistance information to that cell of gNB2 it is now connected to. Also, for example, if the core network (CN) rejected the UE service request for a slice or slice group, then the UE may be redirected by the RAN node to another cell, and the UE may send the report to this new cell (after connecting to that new cell). This delay in obtaining service for a slice, if any, may also be reported as described below.

In some cases, the gNB (e.g., gNB2 that has received the logged information related to the slice specific cell reselection procedure) can match the slice specific cell re-selection report with the outcome, where outcome can be traced via gNB2 logging or collecting information. Also for example, in some cases, the RAN node (gNB2) may know which slices it supports, and knows which slice group UE has requested or UE has selected for slice specific cell reselection, and the gNB2 can determine and report to CN or other RAN nodes (gNBs): statistics of successful cell reselection, e.g., whether or not this UE correctly selected the correct cell and was provided service for this slice group, or not. Also, statistics may be obtained and reported by gNB2 based on or from setup/resume message requests and related admission control or service request outcomes for that specific UE.

At step 5, the source gNB (gNB2) may attempt to obtain service for the UE slice or slice group. The UE may also have previously have attempted to obtain service from one or more cells or gNBs, as part of the cell reselection procedure. The attempting to obtain service may include: transmitting, by the UE to the selected cell, a service request message to request service for one or more slice groups of the user device including at least for the selected slice group; and performing at least one of the following: receiving one of the following: a service accept message that indicates that the service request has been accepted, or a service reject message that indicates that the service request has been rejected; or determining that a service accept message has not been received by the UE, thereby indicating that the service request has likely been rejected. Also, each gNB may perform admission control (at the RAN node), to determine whether to admit a UE, e.g., during RACH procedure. Even though a cell may support a particular slice (e.g., as indicated by the SIB broadcast by the cell), the UE may be denied admission (as part of gNB admission control) by the gNB when the UE is performing random access with such cell/gNB, e.g., if the cell does not have sufficient resources to serve such UE.

At step 6, the gNB2 may compile or create a slice specific cell reselection report, based on the information (logged information received from UE 410) related to the slice specific cell reselection procedure. This may include, for example, selecting and formatting one or more portions, or even all of the logged information received by the gNB2 to be sent to gNB1.

Step 7, Sending the report from gNB2 to gNB1. At step 7, the report (e.g., slice specific cell reselection report) that includes the logged information related to the slice specific cell reselection procedure may be sent from gNB1 to gNB1, which is the gNB that the UE initially camped on and received the slice group specific frequency priorities used by the UE 410 for slice specific cell reselection procedure. Instead of gNB2 directly sending the report to gNB1, the gNB2 may send such slice specific cell reselection report to the core network and the core network may then send or forward such report to neighbor gNBs (e.g., to gNB1). The neighboring gNB (e.g., gNB1) may be made aware of the slice information and the cell conditions. Thus, for example, gNBs may exchange information, such as this report, which may be used for the load management procedure and self-optimization procedure using the Xn interface. gNB1 may receive slice specific cell reselection reports from multiple gNBs, e.g., to report the logged information with respect to multiple UEs that may have performed slice specific cell reselection procedure based on slice group specific frequency priorities provided by gNB1, to allow gNB1 to update or adjust these slice group specific frequency priorities, e.g., to perform load balancing or to achieve some other network performance improvement.

If the core network rejects the UE connection or service request over a period, source gNB (gNB2) may create a slice specific cell re-selection report (that includes the information related to the slice specific cell reselection procedure) and includes them in the management signalling used between RAN nodes. The reports may include the received slice group specific frequency priority and slice group and resulting outcomes of which UE reselected to this cell.

Step 8, Using the report: At step 8, based on the received reports, the neighbour gNB (gNB1) may adjust or update its slice group specific frequency priorities for one or more slices or slice groups, e.g., to improve load balancing among multiple frequencies, among multiple cells, or to reduce a traffic load at a cell(s) for a specific slice, or other objective.

Therefore, gNB2 or the network node to which the UE is connected may forward that report (or portion thereof) to one or more other gNBs, including to gNB 1, which is the gNB that provided the slice specific cell reselection information (e.g., including frequency priorities) used by the UE to perform the cell reselection procedure. The gNB1 may use the slice specific cell reselection report to improve or perform self-optimization of slice specific cell re-selection settings for one or more cells. The self-optimization of slice specific cell reselection settings may be achieved, for example, by changing (e.g., setting or adjusting) the slice group specific frequency priorities for a cell or for multiple cells.

For example, a UE may compile or create a slice specific cell reselection report, e.g., which may be sent as or via a SON (self-organizing networks) report or RFSP (RAT/Frequency Selection Priority report, after it camps on a cell using slice specific cell re-selection. The UE may log information (e.g., problems or other information related to the slice specific cell reselection procedure(s)) and send or transmit the slice specific cell reselection report to a gNB (e.g., gNB1) or network node to report one or more problems or other information, and may also report or indicate the slice specific cell reselection priority (ies) and slice group(s) used for slice specific cell reselection. In this manner, this report may allow a network node to determine a root cause for one or more problems or performance issues, and then may adjust the slice group specific frequency priorities to improve network or cell performance for one or more slices or slice groups, e.g., to reduce a service initiation delay(s) related to a slice or slice group. Also, the network (e.g., gNB) may adjust slice group specific frequency priorities to avoid (or make it less likely) a situation where a UE camps on a cell (via slice specific cell reselection) that does not support the slice or slice group, has a high load or multiple high priority slices.

Note: Reuse of SON procedures for cell specific slice support may enable optimizing the slice grouping through SON algorithms or/and OAM settings. For this purpose, alternatively, collecting the slice information reported by UEs can be implemented in the framework of, or as part of, SON data collection.

Some further examples will be provided.

Example 1. A method comprising: receiving, by a user device, slice specific cell reselection information including slice group specific frequency priorities for one or more slice groups, wherein each slice group is associated with one or more network slices; performing, by the user device, a slice specific cell reselection procedure based on the slice specific cell reselection information; during the performing of the cell reselection procedure, logging, by the user device, information related to the slice specific cell reselection procedure; and transmitting, by the user device to a network node, the information related to the slice specific cell reselection procedure to enable setting or adjusting the slice group specific frequency priorities for one or more slice groups for one or more cells.

Example 2. The method of example 1, wherein the performing the slice specific cell reselection procedure comprises performing the following: selecting, by the user device, a slice group among one or more slice groups of the user device, to perform the slice specific cell reselection procedure; selecting, by the user device, a frequency having a highest priority among a plurality of slice group specific frequency priorities for the selected slice group; performing the following one or more times: measuring, by the user device, reference signals from a plurality of cells via the selected at least one frequency; and selecting, by the user device, a cell among the plurality of cells, based on the measuring.

Example 3. The method of example 2, wherein the performing the slice specific cell reselection procedure comprises: confirming, by the user device, that the selected cell supports the selected slice group.

Example 4. The method of any of examples 2-3, further comprising performing the following one or more times: performing, by the user device, a RRC (radio resource control) connection setup procedure with the selected cell to establish a connection with the selected cell; and attempting to initiate service by sending a service request to the connected cell.

Example 5. The method of example 1, wherein the performing the slice specific cell reselection procedure comprises performing the following: selecting, by the user device, a slice group among one or more slice groups of the user device, to perform the slice specific cell reselection procedure; selecting, by the user device, at least one frequency based on the slice group specific frequency priorities for the selected slice group; measuring, by the user device, reference signals from a plurality of cells via the selected at least one frequency at least once as configured by the network; ranking the plurality of cells based on the measuring; selecting, by the user device, a highest ranked cell among the plurality of cells; receiving system information from the selected cell to confirm that the selected cell supports the selected slice group; and camping, by the user device, on the selected cell.

Example 6. The method of example 5, wherein the selecting at least one frequency comprises: selecting, by the user device, at least one frequency having a highest priority for the selected slice group based on the slice group specific frequency priorities for the selected slice group.

Example 7. The method of example 4, wherein the attempting to initiate service comprises: transmitting, by the user device to the selected cell, a service request message to request service for one or more slice groups of the user device including at least for the selected slice group; and performing at least one of the following: receiving one of the following: a service accept message that indicates that the service request has been accepted, or a service reject message that indicates that the service request has been rejected; or determining that a service accept message has not been received by the user device, thereby indicating that the service request has likely been rejected.

Example 8. The method of example 1, wherein the information related to the cell reselection procedure that is logged by the user device comprises at least: a slice group specific frequency priority used by the user device for the slice specific cell reselection procedure; and information describing or associated with a problem that occurred for the user device in performing the slice specific cell reselection procedure, wherein the problem caused or resulted in a service initiation delay related to a slice or slice group for the user device.

Example 9. The method of any of examples 1-8, wherein the information related to the cell reselection procedure that is logged by the user device comprises: a slice group and a slice group specific frequency priority used by the user for the slice specific cell reselection procedure.

Example 10. The method of example 8, wherein the information describing or associated with a problem comprises at least one of: an indication of one or more cells that were selected by the user device based on measurement of reference signals, but where such one or more cells did not support a slice group used by the user device for the slice specific cell reselection procedure; an indication of one or more cells where the user device established a connection to the cell, but where a service request was rejected; an indication of one or more cells where the user device established a connection to the cell, but where a service request was rejected at least for a slice group that was used by the user device for the slice specific cell reselection procedure or was indicated by the user device in a service request; an indication that no suitable cells, having a reference signal received power greater than a threshold, of an indicated frequency were found that support a slice group used by the user device for the slice specific cell reselection procedure; measurement information, including a number of cell measurements or a number of frequencies measured; a service initiation delay after the slice specific cell reselection procedure was started until service was accepted for a selected slice group for the user device; a number of service request rejections and/or admission control rejections for the user device; and an indication of whether the user device performed multiple measurement iterations of measuring, by the user device, reference signals on the at least one frequency.

Example 11. An apparatus comprising means for performing the method of any of examples 1-10.

Example 12. A non-transitory computer-readable storage medium comprising instructions stored thereon that, when executed by at least one processor, are configured to cause a computing system to perform the method of any of examples 1-10.

Example 13. An apparatus comprising: at least one processor; and at least one memory including computer program code; the at least one memory and the computer program code configured to, with the at least one processor, cause the apparatus at least to perform the method of any of examples 1-10.

Example 14. A method comprising: transmitting, by a first network node to a user device, slice specific cell reselection information including slice group specific frequency priorities for one or more slice groups, wherein each slice group is associated with one or more network slices; receiving, by the first network node from a second network node, a slice specific cell reselection report that includes information related to a slice specific cell reselection procedure performed by the user device based on the slice specific cell reselection information including the slice group specific frequency priorities; and adjusting, by first the network node for one or more cells based on the received slice specific cell reselection report, the slice group specific frequency priorities for one or more slice groups.

Example 15. The method of example 14, wherein the slice specific cell reselection report includes information, reported by the user device to the second network node, related to a slice specific cell reselection procedure performed by the user device based on the slice specific cell reselection information transmitted by the first network node to the user device.

Example 16. The method of any of examples 14-15, wherein the slice specific cell reselection report comprises at least: a slice group specific frequency priority used by the user device for the slice specific cell reselection procedure; and information describing or associated with a problem that occurred for the user device in performing the slice specific cell reselection procedure, wherein the problem caused or resulted in a service initiation delay for the user device.

Example 17. The method of any of examples 14-16, wherein the slice specific cell reselection report further comprises: an indication of whether or not the user device performed multiple measurement iterations of measuring reference signals on at least one or a same frequency.

Example 18. The method of any of examples 14-17, wherein the slice specific cell reselection report comprises at least: a slice group and a slice group specific frequency priority used by the user device for the slice specific cell reselection procedure.

Example 19. The method of example 18, wherein the information describing or associated with a problem that occurred for the user device in performing the slice specific cell reselection procedure comprises at least one of: an indication of one or more cells that were selected by the user device based on measurement of reference signals, but where such one or more cells did not support a slice group used by the user device for the slice specific cell reselection procedure; an indication of one or more cells where the user device established a connection to the cell, but where a service request was rejected; an indication of one or more cells where the user device established a connection to the cell, but where a service request was rejected at least for a slice group that was used by the user device for the slice specific cell reselection procedure or was indicated by the user device in a service request; an indication that no suitable cells, having a reference signal received power greater than a threshold, of an indicated frequency were found that support a slice group used by the user device for the slice specific cell reselection procedure; measurement information, including a number of cell measurements or a number of frequencies measured; a service initiation delay after the slice specific cell reselection procedure was started until service was accepted for a selected slice group for the user device; and a number of service request rejections and/or admission control rejections for the user device; a list of cells, that satisfy a cell reselection measurement criteria, that were found on each measurement iteration on at least one frequency.

Example 20. An apparatus comprising means for performing the method of any of claims 14-19.

Example 21. A non-transitory computer-readable storage medium comprising instructions stored thereon that, when executed by at least one processor, are configured to cause a computing system to perform the method of any of examples 14-19.

Example 22. An apparatus comprising: at least one processor; and at least one memory including computer program code; the at least one memory and the computer program code configured to, with the at least one processor, cause the apparatus at least to perform the method of any of examples 14-19.

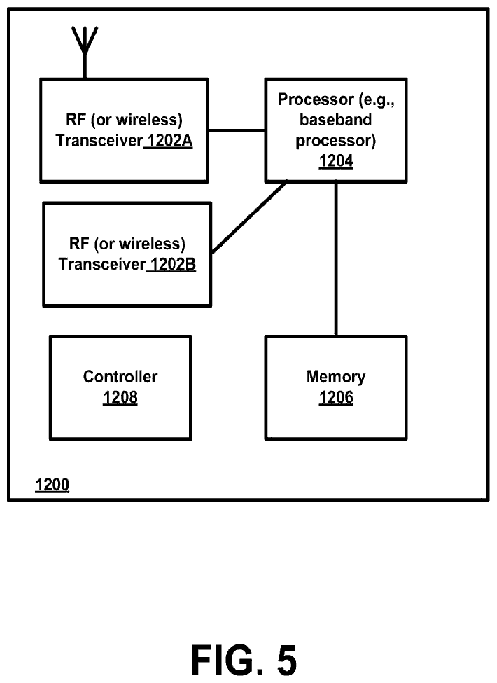

FIG. 5 is a block diagram of a wireless station or node (e.g., UE, user device, AP, BS, eNB, gNB, RAN node, network node, TRP, or other node) 1200 according to an example embodiment. The wireless station 1200 may include, for example, one or more (e.g., two as shown in FIG. 5) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 5, a controller (or processor) 1208 may execute software and instructions, and may provide overall control for the station 1200, and may provide control for other systems not shown in FIG. 5, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine-readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a stand-alone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a back-end component, e.g., as a data server, or that includes a middleware component, e.g., an application server, or that includes a front-end component, e.g., a client computer having a graphical user interface or a Web browser through which a user can interact with an embodiment, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1.-22. (canceled)

23. A method comprising:
receiving, by a user device, slice specific cell reselection information including slice group specific frequency priorities for one or more slice groups, wherein each slice group is associated with one or more network slices;
performing, by the user device, a slice specific cell reselection procedure based on the slice specific cell reselection information;
during the performing of the cell reselection procedure, logging, by the user device, information related to the slice specific cell reselection procedure; and
transmitting, by the user device to a network node, the information related to the slice specific cell reselection procedure to enable setting or adjusting the slice group specific frequency priorities for one or more slice groups for one or more cells.

24. The method of claim 23, wherein the performing the slice specific cell reselection procedure comprises performing the following:
selecting, by the user device, a slice group among one or more slice groups of the user device, to perform the slice specific cell reselection procedure;
selecting, by the user device, a frequency having a highest priority among a plurality of slice group specific frequency priorities for the selected slice group;
performing the following one or more times:
measuring, by the user device, reference signals from a plurality of cells via the selected at least one frequency; and
selecting, by the user device, a cell among the plurality of cells, based on the measuring.

25. The method of claim 24, wherein the performing the slice specific cell reselection procedure comprises:
confirming, by the user device, that the selected cell supports the selected slice group.

26. The method of claim 24, further comprising performing the following one or more times:
performing, by the user device, a RRC (radio resource control) connection setup procedure with the selected cell to establish a connection with the selected cell; and
attempting to initiate service by sending a service request to the connected cell.

27. The method of claim 23, wherein the performing the slice specific cell reselection procedure comprises performing the following:
selecting, by the user device, a slice group among one or more slice groups of the user device, to perform the slice specific cell reselection procedure;
selecting, by the user device, at least one frequency based on the slice group specific frequency priorities for the selected slice group;
measuring, by the user device, reference signals from a plurality of cells via the selected at least one frequency at least once as configured by the network;
ranking the plurality of cells based on the measuring;
selecting, by the user device, a highest ranked cell among the plurality of cells;
receiving system information from the selected cell to confirm that the selected cell supports the selected slice group; and
camping, by the user device, on the selected cell.

28. The method of claim 27, wherein the selecting at least one frequency comprises:
selecting, by the user device, at least one frequency having a highest priority for the selected slice group based on the slice group specific frequency priorities for the selected slice group.

29. The method of claim 26, wherein the attempting to initiate service comprises:
transmitting, by the user device to the selected cell, a service request message to request service for one or more slice groups of the user device including at least for the selected slice group; and
performing at least one of the following:
receiving one of the following: a service accept message that indicates that the service request has been accepted, or a service reject message that indicates that the service request has been rejected; or
determining that a service accept message has not been received by the user device, thereby indicating that the service request has likely been rejected.

30. The method of claim 23, wherein the information related to the cell reselection procedure that is logged by the user device comprises at least:
a slice group specific frequency priority used by the user device for the slice specific cell reselection procedure; and
information describing or associated with a problem that occurred for the user device in performing the slice specific cell reselection procedure, wherein the problem caused or resulted in a service initiation delay related to a slice or slice group for the user device.

31. The method of claim 23, wherein the information related to the cell reselection procedure that is logged by the user device comprises:
a slice group and a slice group specific frequency priority used by the user for the slice specific cell reselection procedure.

32. The method of claim 30, wherein the information describing or associated with a problem comprises at least one of:
an indication of one or more cells that were selected by the user device based on measurement of reference signals, but where such one or more cells did not support a slice group used by the user device for the slice specific cell reselection procedure;
an indication of one or more cells where the user device established a connection to the cell, but where a service request was rejected;
an indication of one or more cells where the user device established a connection to the cell, but where a service request was rejected at least for a slice group that was used by the user device for the slice specific cell reselection procedure or was indicated by the user device in a service request;
an indication that no suitable cells, having a reference signal received power greater than a threshold, of an indicated frequency were found that support a slice group used by the user device for the slice specific cell reselection procedure;
measurement information, including a number of cell measurements or a number of frequencies measured;
a service initiation delay after the slice specific cell reselection procedure was started until service was accepted for a selected slice group for the user device;
a number of service request rejections and/or admission control rejections for the user device; and
an indication of whether the user device performed multiple measurement iterations of measuring, by the user device, reference signals on the at least one frequency.

33. An apparatus comprising means for performing the method of claim 23.

34. An apparatus comprising:
at least one processor; and
at least one memory including computer program code;
the at least one memory and the computer program code configured to, with the at least one processor, cause the apparatus at least to perform the method of claim 23.

35. A method comprising:
transmitting, by a first network node to a user device, slice specific cell reselection information including slice group specific frequency priorities for one or more slice groups, wherein each slice group is associated with one or more network slices;
receiving, by the first network node from a second network node, a slice specific cell reselection report that includes information related to a slice specific cell reselection procedure performed by the user device based on the slice specific cell reselection information including the slice group specific frequency priorities; and
adjusting, by first the network node for one or more cells based on the received slice specific cell reselection report, the slice group specific frequency priorities for one or more slice groups.

36. The method of claim 35, wherein the slice specific cell reselection report includes information, reported by the user device to the second network node, related to a slice specific cell reselection procedure performed by the user device based on the slice specific cell reselection information transmitted by the first network node to the user device.

37. The method of claim 35, wherein the slice specific cell reselection report comprises at least:
a slice group specific frequency priority used by the user device for the slice specific cell reselection procedure; and
information describing or associated with a problem that occurred for the user device in performing the slice specific cell reselection procedure, wherein the problem caused or resulted in a service initiation delay for the user device.

38. The method of claim 35, wherein the slice specific cell reselection report further comprises:
an indication of whether or not the user device performed multiple measurement iterations of measuring reference signals on at least one or a same frequency.

39. The method of claim 35, wherein the slice specific cell reselection report comprises at least:
a slice group and a slice group specific frequency priority used by the user device for the slice specific cell reselection procedure.

40. The method of claim 39, wherein the information describing or associated with a problem that occurred for the user device in performing the slice specific cell reselection procedure comprises at least one of:
an indication of one or more cells that were selected by the user device based on measurement of reference signals, but where such one or more cells did not support a slice group used by the user device for the slice specific cell reselection procedure;
an indication of one or more cells where the user device established a connection to the cell, but where a service request was rejected;
an indication of one or more cells where the user device established a connection to the cell, but where a service request was rejected at least for a slice group that was used by the user device for the slice specific cell reselection procedure or was indicated by the user device in a service request;
an indication that no suitable cells, having a reference signal received power greater than a threshold, of an indicated frequency were found that support a slice group used by the user device for the slice specific cell reselection procedure;
measurement information, including a number of cell measurements or a number of frequencies measured;
a service initiation delay after the slice specific cell reselection procedure was started until service was accepted for a selected slice group for the user device; and
a number of service request rejections and/or admission control rejections for the user device;
a list of cells, that satisfy a cell reselection measurement criteria, that were found on each measurement iteration on at least one frequency.

41. An apparatus comprising means for performing the method of claim 35.

42. An apparatus comprising:
at least one processor; and
at least one memory including computer program code;
the at least one memory and the computer program code configured to, with the at least one processor, cause the apparatus at least to perform the method of claim 35.
